(19) United States
(12) Patent Application Publication
(10) Pub. No.: US 2012/0194341 A1
(43) Pub. Date: Aug. 2, 2012

(54) ACCELEROMETER FEEDBACK CONTROL LOOP FOR PATIENT ALERT

(76) Inventors: David J. Peichel, Minneapolis, MN (US); Lewis J. Werner, Crystal, MN (US); Paul G. Krause, Shoreview, MN (US); Thomas M. Barnhiser, Maple Grove, MN (US); Ryan D. Wyszynski, Oak Grove, MN (US)

(21) Appl. No.: 13/014,756

(22) Filed: Jan. 27, 2011

(51) Int. Cl. G08B 23/00

(52) U.S. Cl. 340/573.1

(57) ABSTRACT

A system and associated method for alerting a patient of a condition detected by an implanted medical device by delivering an alert signal to cause a motion within the patient's body in response to detecting the condition. An accelerometer signal is measured during the alert signal delivery. Accelerometer signal measurements are compared to a threshold. A parameter controlling the alert signal is adjusted to maintain the accelerometer signal within a range of the threshold.

### TECHNICAL FIELD

The disclosure relates generally to implantable medical devices and, in particular, to a method and apparatus for delivering and controlling a patient alert signal.

### BACKGROUND

Numerous implantable medical devices (IMDs) are configured to sense physiological signals for detecting physiological events or for storing data useful in diagnosing a patient condition. Some of these devices deliver a therapy to the patient automatically in response to sensed physiological signals. Others may be monitoring-only devices, which collect data without delivering a therapy. IMDs may be configured to deliver a patient alert signal to make the patient aware of a condition detected by the IMD.

There can be numerous reasons for an IMD to deliver a notification or alert to a patient. An alert may be generated in order to make the patient aware that the IMD is nearing the end of its useful battery life and may need replacement. Other reasons for generating a patient alert include the detection of a lead or sensor performance issue or other device-related issue detected as the result of a self-test or IMD diagnostics. These types of causes for issuing a patient alert can be referred to as “device-related” because the alert is generated to make the patient aware of a condition relating to the IMD function itself.

There may also be patient-related reasons for generating a patient alert or notification. The IMD may detect a physiological condition warranting action by the patient, such as taking a medication, changing a patient activity, or seeking medical attention or advice. Patient alert signals may be generated in response to detecting a serious, life-threatening condition or less serious conditions that warrant medical attention but not urgently. For example, a patient may be alerted when an implantable cardioverter defibrillator (ICD) detects a life-threatening arrhythmia. The patient may be advised to lie down or otherwise prepare for an imminent cardioversion/defibrillation shock when the patient perceives an alert signal. In other embodiments, a patient alert may be generated in response to blood sugar level, or other cardiac or hemodynamic condition, apnea detection or other respiratory condition, and other types of physiological conditions.

Various types of patient alert systems have been proposed. One type of patient alert is an audible alert issuing tones or voiced messages. A drawback of audible alert systems is that a patient may have trouble hearing the alert, e.g. in noisy environments or when the patient has a hearing impairment. Another type of alert involves delivering electrical stimulation pulses to muscle tissue to cause a perceptible muscle twitching or a “vibration” sensation. A potential drawback of this type of alert is that the stimulation may be either too low to elicit a muscle response or too high to cause excessive muscle contraction that is excessively annoying or uncomfortable to the patient. A need remains for a patient alert system that reliably notifies the patient of a device-related or patient-related condition without causing undue discomfort or annoyance to the patient.

### BRIEF DESCRIPTION OF THE DRAWINGS

FIG. 1 is a schematic diagram of one embodiment of an IMD 10 implanted in a patient and configured for delivering a patient alert signal.

FIG. 2 is a functional block diagram 100 of the IMD 10 shown in FIG. 1 according to one embodiment.

FIG. 3 is a flow chart 200 of a method for controlling a patient alert signal according to one embodiment.

FIG. 4 is a flow chart 300 of a method for establishing control parameters for a patient alert signal and an accelerometer signal threshold range according to one embodiment.

### DETAILED DESCRIPTION

In the following description, references are made to illustrative embodiments. It is understood that other embodiments may be utilized without departing from the scope of the disclosure. In some instances, for purposes of clarity, the same reference numbers may be used in the drawings to identify the same or similar elements. As used herein, the term “module” refers to an application specific integrated circuit (ASIC), an electronic circuit, a processor (shared, dedicated, or group) and memory that execute one or more software or firmware programs, a combinational logic circuit, or other suitable components that provide the described functionality.

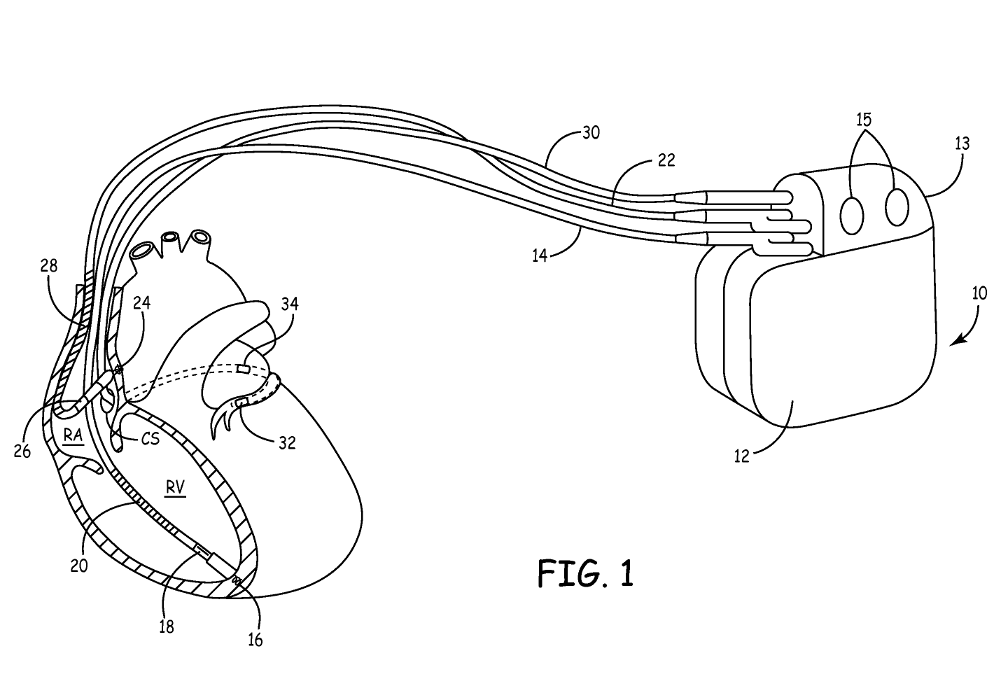

FIG. 1 is a schematic diagram of one embodiment of an IMD 10 implanted in a patient and configured for delivering a patient alert signal. IMD 10 is shown embodied as an ICD, but may alternatively be embodied as any implantable monitoring or therapy delivery device including a cardiac pacemaker, neurostimulator, drug delivery pump, hemodynamic monitor, ECG monitor, or the like. IMD 10 is provided for sensing intrinsic heart activity and delivering cardiac stimulation pulses as appropriate to one or more heart chambers. IMD 10 is adapted for delivering a patient alert signal, which may be delivered in response to detecting an arrhythmia, detecting a particular frequency of arrhythmias, detecting device-related conditions, in advance of delivering a therapy or in response to other alert conditions detected by the IMD 10.

IMD 10 is shown in communication with a patient's heart by way of three leads 14, 22 and 30. The heart is shown in a partially cut-away view illustrating an upper heart chamber, the right atrium (RA), and a lower heart chamber, the right ventricle (RV) and the coronary sinus (CS) in the right atrium leading into the great cardiac vein, which branches to form inferior cardiac veins. Leads 14, 22 and 30 respectively connect IMD 10 with the RV, the RA and the LV via the coronary sinus and cardiac vein. Each lead has at least one electrical conductor and pace/sense electrode. A remote indifferent can electrode 12 is formed as part of the outer surface of the ICD housing. The pace/sense electrodes 16, 18, 24, 26, 32, and 34 and the remote can electrode 12 can be selectively employed to provide a number of unipolar and bipolar pace/sense electrode combinations for pacing and sensing functions.

RA lead 22 is passed through a vein into the RA chamber. RA lead 22 is formed with a connector fitting into a connector bore of the ICD connector block 13 for electrically coupling RA tip electrode 24 and RA ring electrode 26 to ICD internal circuitry via insulated conductors extending within the body of lead 22. RA tip electrode 24 and RA ring electrode 26 may be used in a bipolar fashion, or in a unipolar fashion with can electrode 20, for achieving RA stimulation and sensing of RA electrogram (EGM) signals. RA lead 22 is also provided with a coil electrode 28 that may be used for delivering high voltage cardioversion/defibrillation pulses to the patient's heart in response to the detection of tachycardia or fibrillation.

RV lead 14 is passed through the RA into the RV where its distal end, carrying RV tip electrode 16 and RV ring electrode 18 provide for stimulation in the RV and sensing of RV EGM signals. RV lead 14 also carries a high-voltage coil electrode 20 for use in delivering high voltage cardioversion/defibrillation shocks. In other embodiments, RV lead 14 carries both the RV coil electrode 20 and the SVC coil electrode 28. RV lead 14 is formed with a connector fitting into a corresponding connector bore of the ICD connector block 13 for electrical coupling of electrodes 16, 18, and 20 to IMD internal circuitry.

Coronary sinus lead 30 is passed through the RA, into the CS and further into a cardiac vein to extend the distal LV tip electrode 32 and ring electrode 34 alongside the LV chamber to achieve LV stimulation and sensing of LV EGM signals. The LV CS lead 30 is coupled at a proximal end connector into a bore of the ICD connector block 13 to provide electrical coupling of conductors extending from electrodes 50 and 62 within a body of lead 30 to IMD internal circuitry. In some embodiments, LV CS lead 30 could bear a proximal LA pace/sense electrode positioned along the CS lead body such that it is disposed proximate the left atrium for use in stimulating the LA and/or sensing LA EGM signals.

In addition to the lead-mounted electrodes, IMD 10 may include one or more electrodes 15 formed as uninsulated portions of the ICD housing 20 or positioned along connector block 13. Such electrodes may be employed for delivering a patient alert signal in the form of stimulation of muscle tissue in the vicinity of the subcutaneous or submuscular pocket in which IMD 10 is implanted. Alternatively or additionally, one or more electrodes carried by a lead extending from IMD 10 and tunneled subcutaneously or submuscularly to a desired stimulation site may be used for delivering a patient alert signal. In other embodiments, one electrode carried by a lead, incorporated in connector block 13, or on the IMD housing may be used in combination with any other electrode available for delivering stimulation pulses in the form of a patient alert signal.

While a particular ICD system with associated leads and electrodes is illustrated in FIG. 1, numerous implantable device configurations are possible that include a patient alert system having at least one pair of electrodes for delivering a patient alert signal in the form of muscle stimulation. Such electrodes may be any combination of lead-based or leadless electrodes, including transvenous, subcutaneous, endocardial, epicardial, transcutaneous, or cutaneous electrodes.

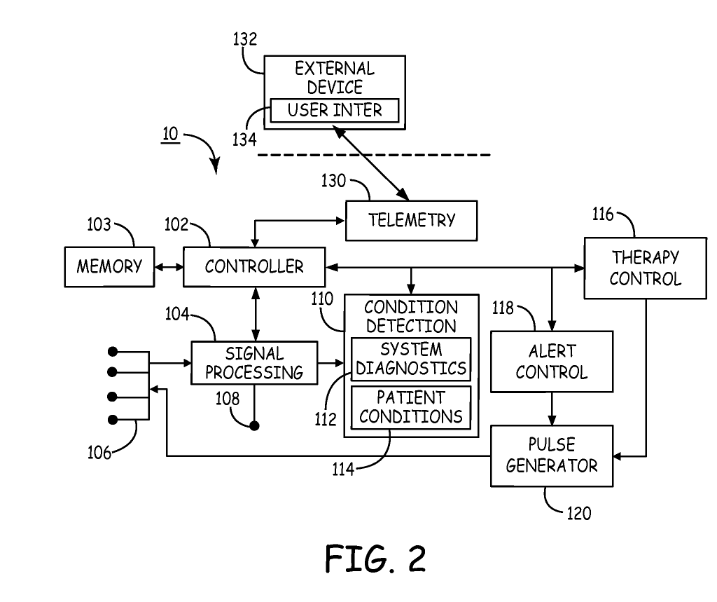

FIG. 2 is a functional block diagram of the IMD 10 shown in FIG. 1 according to one embodiment. IMD 10 generally includes input/output 106 which includes at least one pair of electrodes for delivering a patient alert signal, and a signal processing module 104 receiving signals from input/out 106. An alert condition detection module 110 detects device-related and patient-related conditions. A controller 102 controls device functions using input from signal processor 104 and alert condition detection module 110. IMD 10 further includes a therapy control module 116, an alert control module 118, telemetry module 130, and a pulse generator 120. It is understood that some functions and components of IMD 10 may not be explicitly shown in FIG. 2 for the sake of clarity. Another component that would be present in an IMD, for example, is a battery to supply power to the various IMD components.

Signal processing module 104 may include an analog-to-digital converter and various filters, amplifiers, rectifiers, peak detectors or other signal processing circuitry for processing signals sensed by electrodes included in input/output 106. For example signal processing 104 may detect cardiac signal R-waves, P-waves, or other cardiac signal morphology features or events. Signal processing module 104 may provide sensed event signals as input to condition detector 110. Signal processing 104 may measure impedance signals using electrodes included in input/output 106 for measuring a fluid status of the patient, impedance changes associated with patient hemodynamic function, or for checking the status of a lead or electrode. Such signals may be used by alert condition detection module 110 for detecting a device-related condition using system diagnostics 112 or for detecting patient-related conditions using module 114.

Input/output 106 may include sensors other than electrodes for sensing signals used to detect a patient- or device-related condition. Other sensors used with IMD 10 may include, but are not limited to, a pressure sensor, an oxygen sensor, an acoustical sensor, a temperature sensor, pH sensor, posture sensor, and activity sensor.

Controller 102 may be embodied as a microprocessor operating in association with programmable memory 103, a digital state machine, or other circuitry for controlling sensing, therapy delivery, and patient alert functions in accordance with a programmed operating mode. Controller 102 is coupled to the various components of IMD 10 for sending or receiving signals for controlling device functions.

Therapy control module 116 controls the timing and other aspects of a therapy delivered in response to determining a need for therapy based on sensed physiological signals. A need for therapy may be determined by controller 102 using input from alert condition detection module 110 and/or directly from signal processor 104. Controller 102 may signal therapy control module 116 that a therapy is needed. Therapy control module 116 sets therapy control parameters according to a programmed operating mode. For example, the therapy control parameters may be applied to pulse generator 120 to deliver an electrical stimulation therapy, such as cardiac pacing, cardioversion/defibrillation shock, or neurostimulation. In alternative embodiments, a fluid delivery pump may be included in IMD 10 for delivering a drug, biological agent or other therapeutic fluid instead of or in addition to electrical stimulation therapies.

IMD 10 further includes an accelerometer 108. Accelerometer 108 may be a one-, two-, or three-dimensional accelerometer and may correspond to an activity sensor used by IMD 10 for monitoring patient activity. An activity sensor is generally disclosed in U.S. Pat. No. 6,449,508 (Sheldon, et al.), hereby incorporated herein by reference in its entirety. Accelerometer 108 may be located within the housing of IMD 10 or within or along connector block 13. When an electrode is used to stimulate excitable tissue for delivering a patient alert signal within the subcutaneous or submuscular pocket in which IMD 10 is implanted, a signal from accelerometer 108 located within or along the IMD housing or connector block is used to control the alert signal as will be further described below. When an electrode is used to stimulate excitable tissue at a location away from the IMD, accelerometer 108 may be carried by a lead extending away from IMD 10 to position accelerometer 108 in close proximity to the targeted tissue site for delivering a patient alert stimulation signal.

The accelerometer is positioned to be sensitive to motion caused by delivering stimulation pulses to muscle tissue. As will be further described below, the accelerometer signal is received by signal processing module 104 and used by controller 102 in controlling an alert signal delivered to the patient in a closed-loop feedback method.

Controller 102 uses data obtained from the accelerometer signal to control the alert control module 118 which sets alert stimulation control parameters. Alert stimulation control parameters include pulse amplitude, pulse width, number of pulses in a pulse train, interpulse intervals (i.e. the frequency of pulses within a pulse train), inter-pulse train intervals (i.e. the frequency of pulse trains), pulse shape, and total duration of the alert signal, as well as electrodes and electrode polarity used to deliver the alert signal. The alert stimulation control parameters are applied to pulse generator 120 for delivering one or more pulses to muscle tissue using electrodes included in input/output 106.

Pulse generator 120 is shown to be controlled by both therapy control 116 and alert control 118 for delivering both therapeutic pulses and patient alert signal pulses using electrodes included in input/output 106. It is contemplated that pulse generation circuitry may be included in IMD 10 dedicated to alert signal generation only, separate from pulse generation circuitry used to generate therapeutic stimulation pulses. Furthermore, electrodes being used to deliver a patient alert signal may be dedicated electrodes or used for more than alert signal delivery, such as delivering therapeutic stimulation pulses, sensing cardiac or other electrical signals, measuring impedance, or any combination thereof.

Memory 103 stores a variety of programmed-in operating mode and parameter values that are used by controller 102 in executing algorithms or controlling device operations. The memory 103 may also be used for storing data compiled from sensed physiological signals and/or relating to device operating history for telemetry out upon receipt of a retrieval or interrogation instruction by telemetry module 130. Programming commands or data are transmitted during uplink or downlink telemetry between IMD telemetry circuitry 130 and an external telemetry circuit included in an external device 132, embodied as a programmer, home monitoring unit or patient activator.

The external device 132 includes a user interface 134 which may be used for entering patient feedback for establishing acceptable alert signals. Alert signal control parameters and accelerometer signal threshold ranges used in controlling alert signal delivery may be established in conjunction with patient feedback in an interactive procedure as described below. The user interface may also be used to acknowledge a patient alert signal.

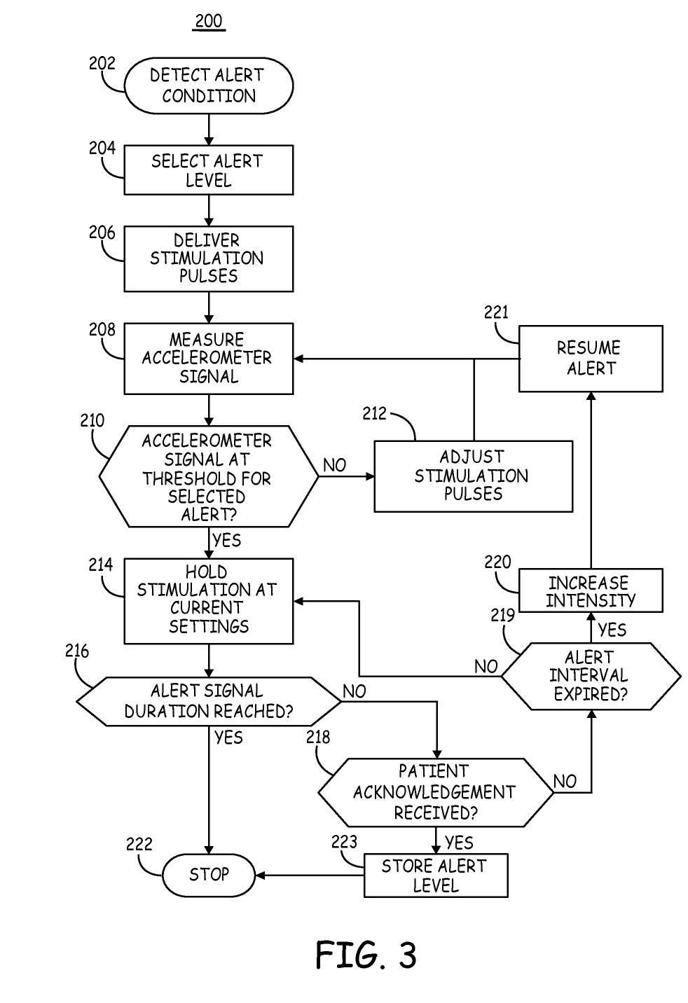

FIG. 3 is a flow chart 200 of a method for controlling a patient alert signal according to one embodiment. Flow chart 200 and other flow charts presented herein are intended to illustrate the functional operation of the device, and should not be construed as reflective of a specific form of software or hardware necessary to practice the methods described. It is believed that the particular form of software will be determined primarily by the particular system architecture employed in the device and by the particular detection and electrical stimulation delivery methodologies employed by the device. Providing software to accomplish the described functionality in the context of any modern IMD, given the disclosure herein, is within the abilities of one of skill in the art.

Methods described in conjunction with flow charts presented herein may be implemented in a computer-readable medium that includes instructions for causing a programmable processor to carry out the methods described. A “computer-readable medium” includes but is not limited to any volatile or non-volatile media, such as a RAM, ROM, CD-ROM, NVRAM, EEPROM, flash memory, and the like. The instructions may be implemented as one or more software modules, which may be executed by themselves or in combination with other software.

At block 202, an alert condition is detected. Methods and apparatus described herein for controlling a patient alert using an accelerometer feedback signal are not limited to any particular type of alert condition or any particular method used to detect an alert condition. Examples of alert conditions have been described above and may include any device-related or patient-related condition detected by the IMD. Illustrative examples of alert conditions may relate to expected battery life, battery replacement required, lead or sensor function, pending therapy delivery, cardiac arrhythmia detection, acute myocardial infarction detection, high or low blood pressure detection or other hemodynamic related condition, low blood oxygen detection, blood sugar level, or the like. The type of patient alert conditions detected will vary with the type of IMD that the alert is implemented in and may be tailored to individual patient need or physician preference.

An IMD may be configured to deliver a patient alert in response to only one condition. In other embodiments, the IMD may be configured to deliver a patient alert signal in response to multiple alert conditions. The same alert signal may be delivered to the patient independent of the type of alert condition detected. Alternatively, the alert signal assigned to a particular alert condition may be unique. For example, the strength or intensity of the stimulation pulses may be higher for more serious or potentially life-threatening conditions and lower for less serious, non-life threatening conditions.

Additionally or alternatively, different patterns of stimulation may be used to indicate to the patient the type of condition being detected. For example, single pulses may be delivered at a relatively low frequency to elicit a mild twitching sensation for one type of alert condition whereas a series of higher frequency pulse trains that result in a series of distinct fused contractions may be delivered to indicate a different type of alert condition has been detected. Patterns of pulse trains of different durations or frequencies may be delivered. For example, patterns that include alternating long and short pulse trains resulting in relatively longer and shorter contractions may be delivered. In another example, pulse trains alternating in higher and lower frequencies, thereby eliciting stronger and weaker contractions of the muscle, respectively, may be delivered to create a unique alert signal. Different combinations of pulse number in a pulse train, pulse frequency, pulse width, pulse amplitude, inter-pulse train intervals and predefined patterns of pulse trains and/or individual pulses may be used to indicate different types of alert conditions and/or different levels of alert severity.

At block 204, an alert is selected that is associated with the detected alert condition. Selection of an alert signal may involve the selection of any of the above listed parameters used to control the alert signal. At block 206, the alert signal stimulation pulses are delivered according to initial settings selected at block 204. For example, a selected pattern and frequency of stimulation pulses and/or pulse trains may be delivered at an initial pulse amplitude and pulse width.

At block 208, the accelerometer signal is measured and compared to an expected threshold level corresponding to the selected alert level at block 210. An alert threshold level may be predefined or tailored to a given patient as will be described further below. If the measured accelerometer response does not correspond to an expected threshold signal level or characteristic pattern of the selected alert signal, the alert signal stimulation pulses are adjusted at block 212 in a closed-loop feedback method until the accelerometer signal measured at block 208 falls within a desired range of an expected threshold level, as determined at block 210. Once the desired alert signal level is reached, the alert signal stimulation parameters are maintained at the current settings at block 214 to maintain the accelerometer signal measurement within a desired range of the threshold. Maintaining the alert signal response within a desired threshold range promotes the reliability of the alert signal in informing the patient of a detected condition.

Determining that the accelerometer signal corresponds to a selected alert threshold at block 210 may involve detecting a magnitude of the accelerometer signal, a frequency of the accelerometer signal, and/or recognizing an intended alert pattern (e.g. short-long burst sequences, strong-weak burst sequences, or the like) based on a morphology of the accelerometer signal. As such, measuring the accelerometer signal at block 208 may involve measuring signal magnitude as well as frequency characteristics during the alert signal delivery. For example, a peak or mean magnitude of a raw accelerometer signal may be measured to determine if the muscle response to the stimulation signal has resulted in motion or twitching of the muscle at a strength that is intended to be perceived by the patient.

Additionally or alternatively, frequency characteristics of the accelerometer signal may be determined to detect muscle motion caused by the patient alert signal. The frequency power band of the accelerometer may be analyzed for correspondence to a frequency of a series of single pulses eliciting muscle twitches, a frequency of partially fused twitches corresponding to a pulse train delivered at a frequency below a full fusion frequency of the stimulated muscle, a frequency of fused contractions occurring in response to a series of pulse trains above the fusion frequency of the muscle, or any combination thereof. Additionally, an accelerometer waveform may be evaluated for correspondence to a particular series of pulse trains or particular pattern of pulses. Such patterns may be selected to be easily discriminated from cardiac motion, respiration motion, typical patient activities or other types of motion that would affect the accelerometer signal. A combination of the amplitude and frequency of the accelerometer signal may also be measured to determine if an intended muscle response to the alert signal has been evoked.

In other embodiments, an activity level count similar to that used to measure patient activity level as disclosed in the above '508 Sheldon patent, incorporated herein by reference in it's entirety, may be used in gauging the muscle response to a desired patient alert signal and verifying that the muscle response causes an expected magnitude and/or frequency of the accelerometer signal.

The alert signal may be terminated if a predetermined maximum alert duration has expired, as determined at block 216. If a maximum alert signal duration is not reached, the alert signal may continue to be held at the current stimulation signal settings at block 214 until the alert expires. Alternatively, the process may return to block 208 to continue monitoring the accelerometer signal throughout the duration of the alert delivery in order to make further adjustments at block 212 as needed to maintain a desired strength and pattern of the patient alert signal. If the alert signal maximum duration is reached, the signal may be immediately terminated at block 222.

In some embodiments, if a patient acknowledgement signal is received prior to the maximum signal duration expiring, as determined at decision block 218, the alert signal is terminated at block 222. A patient acknowledgment may be in the form of a tapping on the IMD housing, use of a patient activator in telemetric communication with the IMD or automatic recognition by the IMD that the patient has responded to the alert signal.

To illustrate, the IMD may sense a patient posture change after initiating the alert signal, e.g. sensing that the patient is lying down, or establish communication with a home monitor as a result of the patient moving into communication range of a home monitoring device. Other responses or actions taken by the patient may be detectable or recognizable by the IMD and treated as a patient acknowledgement at block 218. While not shown explicitly in FIG. 3, if the automatically detected patient action is no longer being detected, for example the patient stands up again or moves out of telemetric range of a home monitor, and the alert condition persists, the alert signal may be restarted.

If patient acknowledgement is not received or detected at block 218, the intensity of the alert signal may be increased at block 220, steadily or in step-wise, pre-determined intervals within an alert signal maximum duration. The intensity may be increased at block 220 according to a predefined pattern by increasing pulse amplitude (up to some maximum), increasing pulse width, increasing pulse frequency or other adjustment that causes a relatively stronger contraction, i.e., greater recruitment of the muscle being stimulated. Adjusting the intensity of the alert signal at block 220 may also be performed using accelerometer signal feedback control by returning to block 208 to compare measured accelerometer signal characteristics to a next higher alert signal threshold level. In other words, the accelerometer signal is compared to a different, increased intensity, threshold than an initial threshold in order to control the alert signal to elicit a stronger response as compared to the initial alert signal settings. Thus for a given alert condition, multiple alert intensity levels may be stored in the IMD memory along with multiple expected accelerometer signal responses or thresholds for each intensity level. The accelerometer signal is used in a closed-loop feedback method to adjust alert signal control parameters to achieve an alert signal with the desired intensity at each level.

The alert signal may be delivered continuously, with continuous or stepwise increasing intensity according to a predefined pattern, until either a maximum alert duration is reached or a patient acknowledgment is received. In other embodiments, an alert signal may be delivered intermittently until patient acknowledgement or expiration of a maximum alert signal duration, whichever occurs earlier. When delivered intermittently, the alert signal is delivered at an initial intensity for a predefined alert interval. The alert signal is held at the current settings at block 214 until the alert interval has expired as determined at block 219. If the alert interval expires, the intensity is increased at block 220 and the alert signal is resumed for another alert signal interval at block 221. A pause between differing alert signal intensities may be applied. For example, the alert signal may be delivered for a 30 second interval at an initial intensity. If no patient acknowledgement is received, a 30 second pause of no alert signal is followed by the alert signal resumed for another 30 second alert interval at an increased intensity. This process may continue until a maximum alert duration is reached as determined at block 216, or patient acknowledgement is received at block 218.

A maximum alert duration may be set at 5 minutes, 10 minutes, 30 minutes, one hour or more and may be set differently for different alert conditions, e.g. according to the seriousness of a particular alert condition. Alert intervals applied during the maximum alert duration may be set differently for different alert conditions and different alert intervals may be applied during a given maximum alert duration. For example, the alert intervals may increase in length as alert signal intensity is increased.

If a maximum alert duration is reached and no patient acknowledgement is received, the alert is terminated at block 222 and optionally repeated at a later time. As described above, a maximum alert duration may correspond to a continuously delivered alert signal, which may be increased in intensity according to a predefined pattern, or an intermittently delivered alert signal that includes successive intervals of increasing intensity of the alert signal with intervening pauses of no alert signal.

In some embodiments, initial alert signal settings may be “learned” over time, based on a patient's response to prior alerting attempts. When a patient acknowledgement is received at block 218, the current alert signal control parameters are stored at block 223. These alert settings may be used as the initial alert signal settings the next time the same alert condition is detected (or another condition using the same alert signal). In this way, if a previous alert was generated and no patient acknowledgement occurred until a particular accelerometer signal amplitude or frequency measurement was reached, the next time the alert is generated, the alert is delivered using the lowest setting at which a patient acknowledgement occurred to improve responsiveness of the patient to alert signals.

Adjustment of stimulation parameters at block 212 is provided for maintaining an alert signal within a targeted threshold level. This adjustment is not limited to parameters defining the stimulation pulses and may include adjusting the electrodes used for delivering the stimulation pulses. Stimulation using a particular electrode pair may become ineffective or less perceptible by a patient over time or during an alert signal due to scar tissue formation causing an increase in the excitation threshold of the muscle, electrode or lead-related issues, muscle fiber fatigue or other causes. Selecting a different electrode pair for delivering a patient alert signal may restore perceptible stimulation at a desired alert level that is verified based on accelerometer signal feedback.

Furthermore, alert signals corresponding to different alert conditions may be distinguished by the patient by delivering the alert signals to different body locations. When alert signals are delivered to different body locations, multiple accelerometers may be required in the IMD system such that an accelerometer signal responsive to alert stimulation at each body location is available. Depending on the number of body locations and relative distance there between, one or more accelerometers may be implanted in order to provide at least one accelerometer in operative relation to each of the targeted alert stimulation sites.

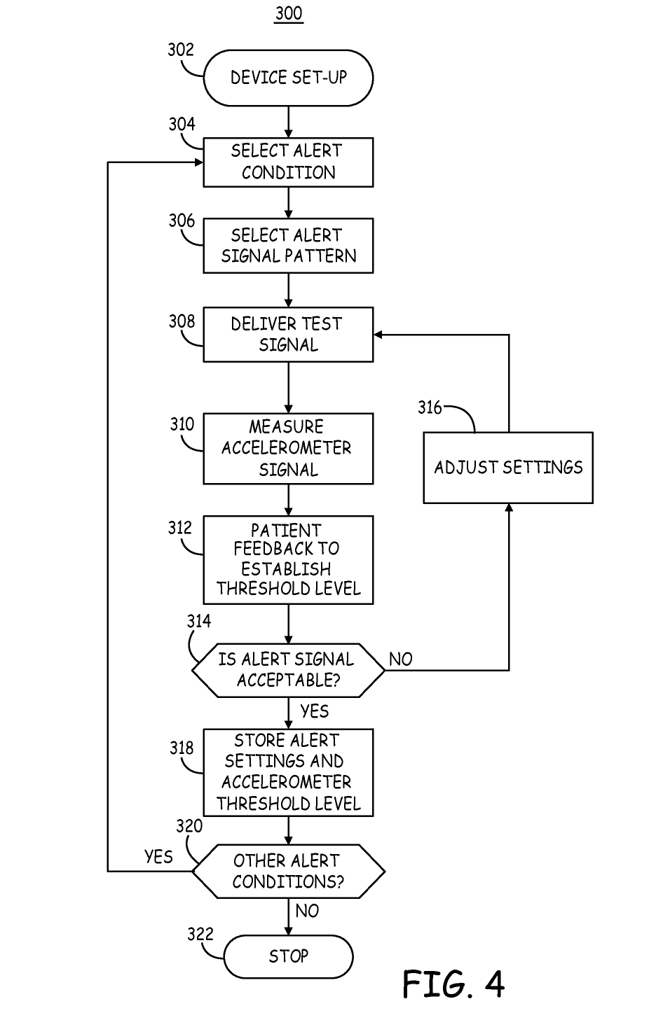

FIG. 4 is a flow chart of a method for establishing control parameters for a patient alert signal and an accelerometer signal threshold range for the alert signal according to one embodiment. At block 302, a device set-up procedure is initiated using an external programmer having a user interface. The process shown in flow chart 300 may be performed at the time of device implantation or during a clinical follow-up visit. The process allows a clinician to establish alert conditions and corresponding alert signals tailored to a particular patient's needs. An alert condition is selected at block 304, which may be a physiological condition monitored by the IMD or a device-related condition detected through self-diagnostic testing or monitoring of device functions. Alert conditions may be predefined or customized for a patient.

At block 306, the clinician selects an alert signal pattern for the alert condition, which may be a default pattern for a selected alert condition or customized using any combination of single pulses, pulse trains of two or more pulses, or any combination thereof. Various parameters controlling the alert stimulation signal may be programmable, such as pulse frequency, pulse number, pulse train frequency, number of pulse trains, pulse train duration, electrodes and electrode polarity, etc.

At block 308, a test signal is delivered to the patient according to the selected signal pattern and any programmable or customized alert signal parameters. The accelerometer signal is measured during the test signal at block 310, which may include measurements of both signal magnitude and frequency characteristics. At block 312, the patient/user may optionally provide feedback to establish whether the test signal is adequately perceivable and distinct from any other alert signals that have already been established. Patient feedback may be received by a user interface included in a patient activator, home monitor, device programmer, or other external device in communication with the IMD. Patient feedback may be received by way of one or more patient taps on the IMD itself when the signal is acceptable or using a signal transmitted by telemetry. An alert signal may be unacceptable to the patient if it causes discomfort, unintended stimulation of non-targeted muscle tissue, or is not adequately perceptible.

If the signal is not acceptable to the patient or not adequately measured by the accelerometer to facilitate closed-loop feedback of the signal, as determined at block 314, one or more alert signal control parameters is adjusted at block 316, and the process at blocks 308 through 314 repeats until an acceptable alert signal is established. The alert signal settings and the accelerometer signal characteristic(s) associated with the acceptable alert signal are stored at block 318 to establish a threshold range of the magnitude and/or frequency characteristics of the accelerometer signal for the given alert signal.

If additional alert conditions are to be detected by the IMD, as determined at block 320, a unique alert signal pattern can be selected for the next alert condition by returning to block 304 and repeating the process shown in blocks 304 through 318. Each alert condition may be assigned a unique patient alert signal that is established by storing expected accelerometer signal characteristics with corresponding alert signal parameters. The patient can provide feedback such that each alert signal is easily perceived, recognized and distinguished from other alert signals.

For each acceptable alert signal, an accelerometer threshold level is established which may include both a magnitude component and a frequency component. The stored accelerometer signal thresholds allow the alert signal to be adjusted as needed during an actual patient alert to most closely match the magnitude and/or frequency characteristics of the established alert signal. The patient can be “trained” to recognize different alert signal patterns, intensities (strength or duration of the muscle response), and/or locations and their correspondence to different alert conditions.

Once all accelerometer-based threshold characteristics have been stored for all alert conditions, the process is terminated at block 322. The stored accelerometer signal data can then be used in a closed-loop feedback method for controlling alert signal stimulation parameters during normal operation of the IMD as described in conjunction with FIG. 3.

While the illustrative embodiments described herein pertain in particular to a patient alert system that involves electrical stimulation of innervated muscle to cause recruitment of muscle fibers and a resulting motion within the patient that is perceivable by the patient, it is recognized that other types of alert signals that cause motion within and perceivable by the patient may be implemented with the use of accelerometer-based feedback control as described herein. Such systems include those implementing a mechanical vibration of the IMD housing or other component of the implanted system or other motion within the patient imparting a perceptible vibration or movement. Such mechanical vibration or motion could be imparted using, for example, a piezoelectric device or other mechanically, thermally, or electrically-actuated vibrating device. In such embodiments, the IMD shown in FIG. 2 would include a vibrating device, within the IMD housing or an associated lead, and an actuation signal source coupled to the vibrating device for causing the device to vibrate as controlled by the alert signal controller in response to a detected alert condition.

Thus, an accelerometer-based feedback control system and method for delivering patient alert signals have been presented in the foregoing description with reference to specific embodiments. It is appreciated that various modifications to the referenced embodiments may be made without departing from the scope of the disclosure as set forth in the following claims.

1. A method for alerting a patient of a condition detected by an implanted medical device, comprising:
delivering an alert signal to cause a motion within the patient's body in response to detecting the condition;
measuring an accelerometer signal during the alert signal delivery;
comparing the accelerometer signal measurement to a threshold; and
adjusting a parameter controlling the alert signal to maintain the accelerometer signal within a range of the threshold.

2. The method of claim 1, wherein delivering the alert signal comprises delivering a plurality of electrical stimulation pulses using an electrode pair for stimulating excitable tissue.

3. The method of claim 1, wherein delivering the alert signal comprises causing a mechanical vibration.

4. The method of claim 2, wherein adjusting the parameter comprises adjusting one of a stimulation pulse amplitude, a pulse number, a pulse frequency, an alert signal duration, an electrode delivering the plurality of stimulation pulses, an electrode polarity, and a pattern of the plurality of stimulation pulses.

5. The method of claim 1, wherein measuring the accelerometer signal comprises measuring one of a signal magnitude and a signal frequency.

6. The method of claim 1, wherein measuring the accelerometer signal comprises measuring a morphology of the accelerometer signal, and wherein the threshold range comprises a waveform morphology corresponding to an alert signal pattern.

7. The method of claim 1, further comprising receiving patient feedback for establishing an acceptable alert signal.

8. The method of claim 1, further comprising:
delivering an alert signal to establishing the threshold;
measuring the accelerometer signal during the delivered alert signal; and
storing the threshold in response to a measured parameter of the accelerometer signal.

9. The method of claim 1, further comprising:
detecting a patient acknowledgement; and
terminating the alert signal in response to detecting the patient acknowledgement.

10. The method of claim 9, further comprising increasing an intensity of the alert signal if a patient acknowledgement is not detected.

11. The method of claim 10, wherein increasing the intensity comprises adjusting an electrical stimulation control parameter that causes increased recruitment of muscle fibers in the patient.

12. The method of claim 1, further comprising:
detecting a patient acknowledgement;
increasing an intensity of the alert signal if a patient acknowledgement is not detected;
detecting a patient acknowledgement in response to increasing the intensity of the alert signal;
storing alert signal control parameters corresponding to the increased intensity associated with the detected patient acknowledgement; and
initiating a next alert signal in response to detecting a subsequent alert condition at the stored alert signal control parameters associated with the detected patient acknowledgement.

13. An implantable medical device system for alerting a patient of a condition detected by an implanted medical device, comprising;
a detector for detecting an alert condition;
a patient alert signal generator for delivering an alert signal by causing a motion within the patient's body in response to the detected condition;
an accelerometer for sensing a signal correlated to the motion; and
a controller for receiving the accelerometer signal, measuring the accelerometer signal, comparing the accelerometer signal measurement to a threshold, and controlling the generator to maintain the accelerometer signal within a range of the threshold during delivery of the alert signal.

14. The system of claim 13, further comprising at least one electrode pair coupled to the generator, wherein the generator comprises an electrical pulse generator for delivering a plurality of electrical stimulation pulses to excitable tissue using the electrode pair.

15. The system of claim 13, wherein the generator comprises:
a vibrating device; and
an actuation signal source coupled to the vibrating device.

16. The system of claim 14, wherein the controller is configured to control the generator by adjusting one of a stimulation pulse amplitude, a pulse number, a pulse frequency, an alert signal duration, an electrode delivering the plurality of stimulation pulses, an electrode polarity and a pattern of the plurality of stimulation pulses.

17. The system of claim 13, wherein the controller is configured to measure one of an accelerometer signal magnitude and an accelerometer signal frequency.

18. The system of claim 13, wherein the controller is configured to measure a morphology of the accelerometer signal, and wherein the threshold range comprises a morphology corresponding to an alert signal pattern.

19. The system of claim 13, further comprising means for receiving patient feedback for establishing an acceptable alert signal.

20. The system of claim 13, wherein the controller is further configured to establish the threshold range by controlling the generator to deliver an alert signal, measure the accelerometer signal during the alert signal, and store the threshold range in response to a measured parameter of the accelerometer signal.

21. The system of claim 13, wherein the controller is further configured to detect a patient acknowledgement and terminate the alert signal in response to detecting the patient acknowledgement.

22. The system of claim 21, wherein the controller is further configured to increase an intensity of the alert signal if a patient acknowledgement is not detected.

23. The system of claim 22, wherein increasing the intensity comprises adjusting an electrical stimulation control parameter that causes increased recruitment of muscle fibers in the patient.

24. The system of claim 22 wherein the controller is further configured to receive a patient acknowledgement at the increased intensity of the alert signal; store alert signal control parameters corresponding to the increased intensity associated with the patient acknowledgement; and initiate a next alert signal in response to detecting a subsequent alert condition at the stored alert signal control parameters associated with the patient acknowledgement.

25. A computer-readable medium storing a set of computer-executable instructions for performing a method for alerting a patient of a condition detected by an implanted medical device, the method comprising:
delivering an alert signal to cause a motion within the patient's body in response to detecting the condition;
measuring an accelerometer signal during the alert signal delivery;
comparing the accelerometer signal measurement to a threshold; and
adjusting a parameter controlling the alert signal to maintain the accelerometer signal within a range of the threshold.
